(19) United States
(12) Patent Application Publication
(10) Pub. No.: US 2024/0080299 A1
(43) Pub. Date: Mar. 7, 2024

(54) CONTROLLER-BASED NETWORK ACCESS CONTROL SYSTEM, AND METHOD THEREOF

(71) Applicant: PRIBIT Technology, Inc., Seoul (KR)

(72) Inventor: Young Rang KIM, Seoul (KR)

(21) Appl. No.: 18/503,786

(22) Filed: Nov. 7, 2023

Related U.S. Application Data
(63) Continuation of application No. PCT/KR2022/006027, filed on Apr. 27, 2022.

(30) Foreign Application Priority Data
May 7, 2021 (KR) 10-2021-0059273

(51) Int. Cl. H04L 9/40

(52) U.S. Cl. CPC H04L 63/0236; H04L 63/0876; H04L 63/102

(57) ABSTRACT

A node according to an embodiment of the present disclosure includes a communication circuit, a processor operatively connected to the communication circuit, and a memory operatively connected to the processor and that stores a target application and an access control application, and the memory stores instructions that, when executed by the processor, cause the node to receive tunnel generation information necessary to generate a gateway and a tunnel from an external server, through the access control application, to request the gateway to generate the tunnel based on the tunnel generation information, through the access control application, to receive static IP information assigned to the node or each user of the node from the gateway, through the access control application, and to transmit the static IP information to the external server, through the access control application.

### CROSS REFERENCES

The application is a continuation of International Application No. PCT/KR2022/006027, filed Apr. 27, 2022, which claims the benefit of priority based on Korean Patent Application No. 10-2021-0059273, filed on May 7, 2021, the disclosures of each of which are hereby expressly incorporated by reference herein in their entireties.

### TECHNICAL FIELD

The present disclosure relates to a system for controlling a controller-based network access and a method therefor.

### BACKGROUND

Multiple devices may communicate data over a network. For example, a smartphone may transmit or receive data to and from a server via the Internet. The network may include a private network such as an intranet as well as a public network such as the Internet.

To control indiscriminate access with respect to a network, a technology for limiting access to the network is being applied based on a transmission control protocol (TCP)/internet protocol (IP). For example, a NAC (network access controller) allows an authorized terminal to access a network by receiving an authorized IP address, and has a method of blocking unauthorized terminals using an ARP (address resolution protocol) spoofing when an unauthorized terminal uses an unauthorized IP address. A firewall has a method of determining whether to allow transmission of a data packet based on source IP, destination IP, and port information included in IP header information and a policy. A virtual private network (VPN) has a method of ensuring the integrity and confidentiality of data packets by using a tunnel to which encryption is applied over the TCP/IP protocol.

The ARP spoofing puts a load on the network, and technologies to bypass the load have recently been developed. Since the firewall is for controlling the flow of data packets, it may not be directly involved in the process of generating a connection between two nodes. Also, the VPN is vulnerable to the management of the flow of data packets after the tunnel is generated. In addition, since the above technologies are based on the TCP/IP, security of another layer (e.g., an application layer) among open system interconnection (OSI) layers may be vulnerable. Korean Patent No. 10-2204705 proposes a method to solve the above problems, and specifically, an access control application stored in a node transmits or drops data packets of an application through a tunnel authorized by a controller to prevent malicious attacks in units of applications.

In Korean Patent No. 10-2204705, the tunneling IP assigned to the node is randomly assigned by a DHCP (dynamic host configuration protocol) according to the tunneling IP band set in a gateway. Since this method may not precisely control the access of an unspecified number of nodes (or terminals) coming from the Internet band, a network access control solution that controls data packets based on firewall or IP 5 Tuples information may be partially utilized. In this case, since a source IP may be specified, an access control is possible only for nodes accessed through an authorized tunnel, but unlike network access control solutions that control data packets with a source IP, a destination IP, and port information, the gateway of Korean Patent No. 10-2204705 performs the process of authenticating and identifying nodes, users, and applications, so it is necessary to control the source IP for each node and user.

In addition, the DHCP provides a static IP based on a MAC address, but the terminal accessed by the user may change depending on the situation, and since it is difficult to specify the MAC address for a terminal connected to the Internet that passes through multiple hops, a static IP needs to be assigned to each user and terminal.

Various embodiments disclosed in this document are intended to provide a system for solving the above-described problems in a network environment and a method therefor.

### SUMMARY

According to an embodiment of the present disclosure, a node includes a communication circuit, a processor operatively connected to the communication circuit, and a memory operatively connected to the processor and that stores a target application and an access control application, and the memory stores instructions that, when executed by the processor, cause the node to receive tunnel generation information necessary to generate a gateway and a tunnel from an external server, through the access control application, to request the gateway to generate the tunnel based on the tunnel generation information, through the access control application, to receive static IP information assigned to the node or each user of the node from the gateway, through the access control application, and to transmit the static IP information to the external server, through the access control application.

According to an embodiment of the present disclosure, a server includes a communication circuit, a memory storing a database, and a processor operatively connected to the communication circuitry and the memory, and the processor receives a controller access request or a user authentication request from a node, and the received request being including identification information of a control flow generated between the server and the node, generates tunnel generation information necessary to generate a tunnel when it is necessary to generate the tunnel between the node and a gateway, and sets IP and DNS information to assign to the node or a user of the node, transmits the tunnel generation information to the node and the gateway, receives a tunnel generation notification from the node indicating that the tunnel between the node and the gateway is generated, and the tunnel generation notification being including IP information, determines whether the IP information included in the tunnel generation notification is the same as the set IP, transmits a data flow including a destination IP and port information transmittable with the IP to the gateway when the IP information is the same as the IP, and requests the node and the gateway a removal of the tunnel when the IP information is not the same as the IP.

According to an embodiment of the present disclosure, a gateway receives a data flow indicating a destination IP and port information transmittable with a static IP assigned to a node, from an external server, receives a data packet from an access control application of the node, inspects a tunnel and data flow through which the data packet is received, determines whether a source IP included in the data packet is the same as the static IP included in the data flow when the inspection is successful, and drops or forwards the data packet based on the determination result.

According to an embodiment of the present disclosure, an operating method of a node includes receiving tunnel generation information necessary to generate a gateway and a tunnel from an external server, requesting the gateway to generate the tunnel based on the tunnel generation information, receiving static IP information assigned to the node or each user of the node from the gateway, and transmitting the static IP information to the external server.

According to an embodiment of the present disclosure, an operating method of a server includes receiving a controller access request or a user authentication request from a node, and the received request being including identification information of a control flow generated between the server and the node, generating tunnel generation information necessary for a tunnel generation and setting IP and DNS information to be assigned to the node or a user of the node when it is necessary to generate a tunnel between the node and a gateway, transmitting the tunnel generation information to the node and the gateway, receiving a tunnel generation notification from the node indicating that the tunnel between the node and the gateway is generated, and the tunnel generation notification being including IP information, determining whether IP information included in the tunnel generation notification is the same as the set IP, and transmitting a data flow including a destination IP and port information transmittable with the IP to the gateway when the IP information is the same as the IP, and requesting the node and the gateway to remove the tunnel when the IP information is not the same as the IP.

According to an embodiment of the present disclosure, an operating method of a gateway includes receiving, from an external server, a data flow indicating a destination IP and port information transmittable with a static IP assigned to a node, receiving a data packet from an access control application of the node, inspecting a tunnel and data flow through which the data packet is received, determining whether a source IP included in the data packet is the same as the static IP included in the data flow when the inspection is successful, and dropping or forwarding the data packet based on the determination result.

According to embodiments of the present disclosure, a system for controlling a network access may predefine access policies for each terminal and user to a firewall and network access control solution after the gateway existing at the network border, and may safely control an access through technologies such as firewalls even if a gateway failure or security vulnerability occurs.

In addition, according to embodiments of the present disclosure, since the gateway performs its own firewall function through a static IP, blocking may be performed even if an unauthorized application transmits data packets by bypassing the access control application to access an unauthorized network.

In addition, according to embodiments of the present disclosure, a system for controlling a network access may induce the terminal accessed through tunneling to be accessed by a DNS (Domain Name System) by providing DNS information along with a static IP to facilitate an access to the cloud or internal network.

These and other aspects are merely illustrative of the innumerable aspects associated with the present disclosure and should not be deemed as limiting in any manner. These and other aspects, features, and advantages of the present disclosure will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the present disclosure and wherein similar reference characters indicate the same parts throughout the views.

FIG. 1 illustrates an environment including a plurality of networks.

FIG. 2 illustrates an architecture in a network environment according to various embodiments.

FIG. 3 is a functional block diagram illustrating a database stored in a controller according to various embodiments.

FIG. 4 is a functional block diagram of a node according to various embodiments.

FIG. 5 illustrates an operation of controlling reception of a data packet according to various embodiments.

FIG. 6 illustrates a signal flow diagram for a controller access according to various embodiments.

FIG. 7 illustrates a signal flow diagram for a user authentication according to various embodiments.

FIG. 8 illustrates a signal flow diagram for a tunnel generation according to various embodiments.

FIG. 9 illustrates a signal flow diagram for notifying completion of a tunnel generation according to various embodiments.

FIG. 10 illustrates a signal flow diagram for controlling a network access according to various embodiments.

FIG. 11 illustrates a signal flow diagram for releasing a network access according to various embodiments.

FIG. 12 illustrates a flowchart of an operation of a node for a tunnel generation according to various embodiments.

FIG. 13 illustrates a flowchart of an operation of a server for a tunnel generation according to various embodiments.

FIG. 14 illustrates a flowchart of an operation of a gateway for forwarding a data packet according to various embodiments

### DETAILED DESCRIPTION

Hereinafter, various embodiments of the disclosure may be described with reference to accompanying drawings. However, those of ordinary skill in the art will recognize that modification, equivalent, and/or alternative on various embodiments described herein may be variously made without departing from the scope and spirit of the disclosure.

As used herein, singular forms of noun corresponding to an item in the disclosure may include one or more items, unless the context clearly indicates otherwise. In the disclosure disclosed herein, each of the expressions “A or B”, “at least one of A and B”, “at least one of A or B”, “A, B, or C”, “one or more of A, B, and C”, or “one or more of A, B, or C”, and the like used herein may include any and all combinations of one or more of the associated listed items. The expressions, such as “a first”, “a second”, “the first”, or “the second”, may be used merely for the purpose of distinguishing a component from the other components, but do not limit the corresponding components in other aspect (e.g., the importance or the order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

Each component (e.g., the module or the program) of the components described in the disclosure may include one or plural entities. According to various embodiments, at least one or more components of the above components or operations may be omitted, or one or more components or operations may be added. Alternatively or additionally, some components (e.g., the module or the program) may be integrated in one component. In this case, the integrated component may perform the same or similar functions performed by each corresponding components prior to the integration. According to various embodiments, operations performed by a module, a programming, or other components may be executed sequentially, in parallel, repeatedly, or in a heuristic method, or at least some operations may be executed in different sequences, omitted, or other operations may be added.

The term “module” used in the disclosure may include a unit implemented in hardware, software, or firmware and may be interchangeably used with the terms “logic”, “logical block”, “part” and “circuit”. The “module” may be a minimum unit of an integrated part or may be a part thereof. The “module” may be a minimum unit for performing one or more functions or a part thereof. For example, according to an embodiment, the “module” may include an application-specific integrated circuit (ASIC).

Various embodiments of the disclosure may be implemented by software (e.g., a program or an application) including a one or more instructions stored in a machine-readable storage medium (e.g., a memory) readable by a machine. For example, the processor of a machine may call the instruction from the machine-readable storage medium and execute the instructions thus called. This means that the machine may perform at least one function based on the called at least one instruction. The one or more instructions may include a code generated by a compiler or executable by an interpreter. The machine-readable storage medium may be provided in the form of non-transitory storage medium. Here, the term “non-transitory”, as used herein, means that the storage medium is tangible, but does not include a signal (e.g., an electromagnetic wave). The term “non-transitory” does not differentiate a case where the data is permanently stored in the storage medium from a case where the data is temporally stored in the storage medium.

The method according to various embodiments disclosed in the disclosure may be provided as a part of a computer program product. The computer program product may be traded between a seller and a buyer as a product. The computer program product may be distributed in the form of machine-readable storage medium (e.g., a compact disc read only memory (CD-ROM)) or may be directly distributed (e.g., download or upload) online through an application store (e.g., a Play Store™) or between two user devices (e.g., the smartphones). In the case of online distribution, at least a portion of the computer program product may be temporarily stored or generated in a machine-readable storage medium such as a memory of a manufacturer's server, an application store's server, or a relay server.

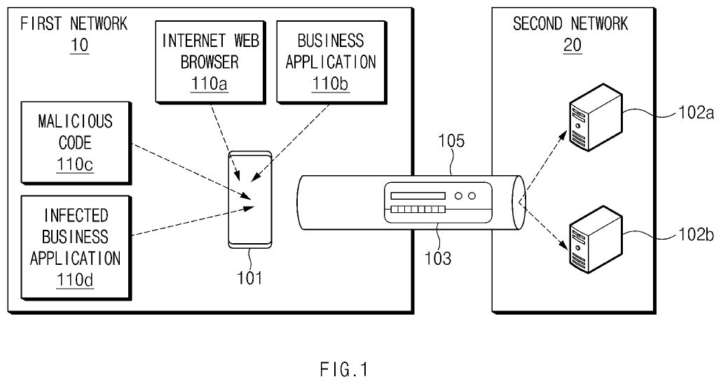

FIG. 1 illustrates an environment including a plurality of networks.

Referring to FIG. 1, a first network 10 and a second network 20 may be different networks. For example, the first network 10 may be a public network such as the Internet, and the second network 20 may be a private network such as an intranet or the VPN.

The first network 10 may include a source node 101. In FIG. 1 and the embodiments described below, the ‘source node’ may be various types of devices capable of performing data communication. For example, the source node 101 may be a portable device such as a smartphone or tablet, a computer device such as a desktop or laptop, a multimedia device, a medical device, a camera, a wearable device, a virtual reality (VR) device, or home appliances, and is not limited to the above-mentioned devices. For example, the source node 101 may include a server or gateway that may transmit data packets through an application. The source node 101 may also be referred to as an ‘electronic device’ or a ‘terminal’. Meanwhile, a destination node 102 may mean a device identical to or similar to the above-described source node 101 or a service server.

The source node 101 may attempt to access the second network 20 and may transmit data to the destination node 102 included in the second network 20. The source node 101 may transmit data to the destination node 102 through a gateway 103 and a tunnel 105.

When an access of the source node 101 with respect to the first network 10 is approved, the source node 101 may communicate with all servers included in the first network 10, so that the source node 101 may be exposed to attacks by malicious programs. For example, the source node 101 may receive data of untrusted or unsecured applications such as a malicious code 110c and an infected business application 110d, as well as data of trusted and/or secure applications such as an internet web browser 110a and a business applications 110b.

The source node 101 infected by a malicious program may attempt to access to the second network 20 and/or to transmit data. When the second network 20 is formed based on IP, such as a VPN, it may be difficult for the second network 20 to individually monitor a plurality of devices included in the second network 20, and security may be vulnerable to an application layer or a transmission layer in OSI layers. In addition, when the source node 101 includes a malicious application after the tunnel is generated in advance, the data of the malicious application will be transferred to another electronic device (e.g., the destination node 102) within the second network 20.

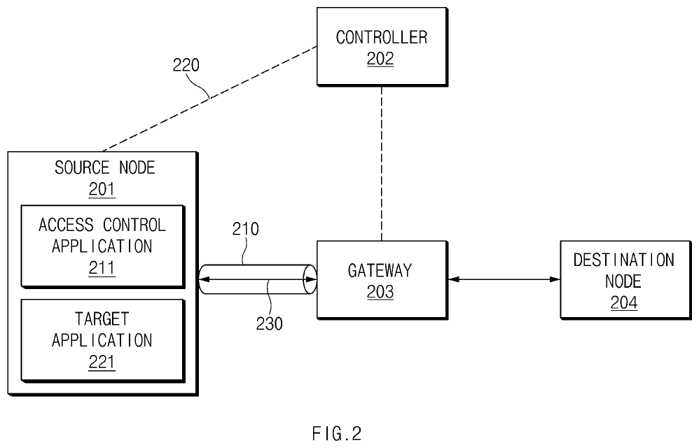

FIG. 2 illustrates an architecture in a network environment according to various embodiments. Referring to FIG. 2, a source node 201, a gateway 203, and a destination node 204 may each perform the same or similar functions as the components with the same name among the components illustrated in FIG. 1.

A controller 202 may manage one or more source nodes 201, the gateways 203, and the destination node 204. The controller 202 may be, for example, a server (or cloud server). The controller 202 may ensure reliable data transmission within a network environment by managing data transmission between the source node 201, the gateway 203, and the destination node 204. For example, the controller 202 may manage the access of the source node 201 with respect to the destination node 204 through policy information or blacklist information, may mediate the generation of an authorized tunnel 210 between the source node 201 and the gateway 203, or may remove the tunnel 210 according to security events collected from the source node 201 or the gateway 203. The source node 201 may communicate with the destination node 204 only through the tunnel 210 authorized by the controller 202, and when the authorized tunnel 210 does not exist, the source node 201 may be blocked from network accessing to the destination node 204. According to an embodiment, the controller 202 exchanges control data packets with the source node 201 to perform various operations (e.g., registration, approval, authentication, update, termination) associated with the network access of the source node 201. A flow (e.g., 220) through which control data packets are transmitted may be referred to as a ‘control flow’.

The gateway 203 may be located at the border of the network to which the source node 201 belongs or the border of the network to which the destination node 204 belongs. There may be multiple gateways 203. The gateway 203 may forward only data packets received through the authorized tunnel 210 among the data packets received from the source node 201 to the destination node 204. A flow (e.g., 230) in which data packets are transmitted between the source node 201 and the gateway 203, the gateway 203 and the destination node 204, or the source node 201 and the destination node 204 may be referred to as a ‘data flow’. Compared to the tunnel 210 generated on a terminal or an IP unit, the data flow may be generated in more detailed units (e.g., application). According to an embodiment, the gateway 203 may be connected to the controller 202 on a cloud basis. The gateway 203 may generate the source node 201 and the authorized tunnel 210 under the control of the controller 202.

According to various embodiments, the source node 201 may include an access control application 211 for managing a network access of applications stored in the source node 201 and a network driver (not illustrated). For example, when a network access event occurs for the destination node 204 of a target application 221 (e.g., any one of the applications 110a to 110d in FIG. 1) included in the source node 201, the access control application 211 may determine whether the target application 221 is accessible. When the target application 221 is accessible, the access control application 211 may transmit a data packet to the gateway 203 through the tunnel 210. The access control application 211 may control the transmission of data packets within the source node 201 through a kernel including an operating system and a network driver.

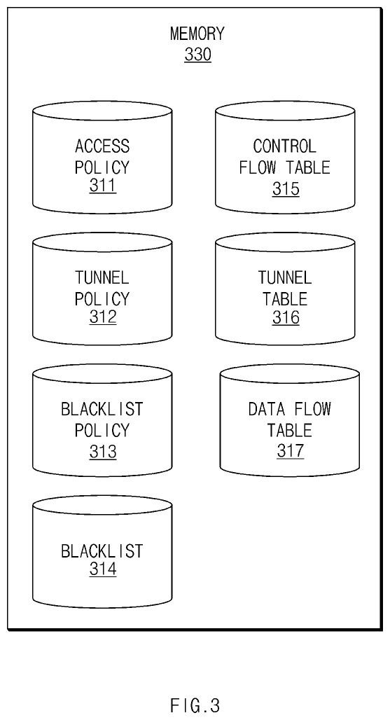

FIG. 3 is a functional block diagram illustrating a database stored in a controller (e.g., the controller 202 of FIG. 2) according to various embodiments.

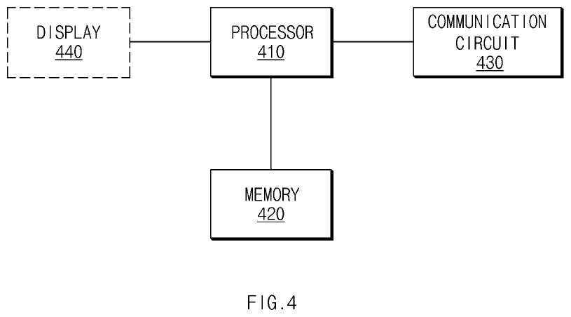

Referring to FIG. 3, the controller may store databases 311 to 317 for controlling network access and data transmission in the memory 330. Although FIG. 3 illustrates only a memory 330, the controller may further include a communication circuit (a communication circuit 430 in FIG. 4) for communicating with an external electronic device (e.g., the source node 201, the gateway 203, or the destination node 204 of FIG. 2), and a processor (e.g., a processor 410 in FIG. 4) for controlling the overall operation of the controller.

The access policy database 311 may include information about networks and/or services to which an identified network, source node, destination node, user, or application are accessible. For example, the controller may determine whether the identified network (e.g., the network to which the source node belongs), the source node, a user (e.g., the user of the source node), and/or an application (e.g., the application included in the source node) are accessible to the destination node, based on the access policy database 311. The controller may generate whitelist information of target applications accessible to a specific destination node (or an IP and port of the destination network) based on the access policy database 311.

The tunnel policy database 312 may include the type, encryption method, and encryption level information of the tunnel to be connected to the gateway existing at the border of the network and the source node (e.g., the terminal) on a connection path. For example, the controller may provide the source node with the optimal tunnel for accessing the destination node and information about the tunnel, based on the tunnel policy database 312.

The blacklist policy database 313 may include a policy for permanently or temporarily blocking the access to a specific node (e.g., a source node or a destination node). The blacklist policy database 313 may be generated based on information (e.g., at least one of a source node ID (identifier), an IP address, a MAC (media access control) address, or a user ID) identified through analysis of security event risk, occurrence cycle, and/or behavior among security events periodically collected from the source node, destination node, or gateway.

The blacklist database 314 may include a list of at least one of a source node, a destination node, an IP address, a MAC address, or a user blocked by the blacklist policy database 313. For example, when the identification information of the source node requesting the access to the destination node is included in the blacklist database 314, the controller may isolate the source node from the destination node by rejecting the access request of the source node.

The control flow table 315 is an example of a session table for managing a flow (e.g., the control flow) of control data packets generated between the node (e.g., the source node or the destination node) and the controller. When successfully accessing to the controller, the control flow information may be generated by the controller. The control flow information may include at least one of control flow identification information, an IP address identified when accessing to and authenticating the controller, a node ID, or a user ID. For example, when the access to a destination node is requested from a source node, the controller may retrieve the control flow information through the control flow identification information received from the source node, and may map at least one of the IP address, source node ID, or user ID included in the retrieved control flow information to the access policy database 311, thereby determining whether the access of the source node is possible and whether to generate a tunnel.

According to an embodiment, the control flow may have an expiration time. A node (e.g., a source node or a destination node) should update the expiration time of the control flow, and when the expiration time is not updated within a certain period of time, the control flow (or the control flow information) may be removed. Additionally, when it is determined that immediate access blocking is necessary according to security events collected from a node or gateway, the controller may remove the control flow according to access termination request of the node. When the control flow is removed, the tunnel generated in advance and the data flow are also removed, so the access of the node may be blocked.

The tunnel table 316 is a table for managing tunnels connected between the source node and the gateway. The tunnel may be generated in a device unit or IP unit, for example. When a tunnel is generated between a source node and a gateway, the tunnel table 316 may include tunnel identification information, control flow identification information when the tunnel is dependent on a control flow, a tunnel end point (TEP), a tunnel start point (TSP), a tunnel algorithm, a tunnel type, and/or additional information for managing a tunnel. In an embodiment, the tunnel table 316 may include authentication information for assigning a static IP in units of nodes or users.

The data flow table 317 is a table for managing the flow (e.g., the data flow) in which detailed data packets are transmitted between the source node and the destination node. The data flow may be generated in units of TCP sessions, applications, or more granular levels within tunnels generated in units of nodes or IPs. The data flow table 317 may include data flow identification information, control flow identification information when the data flow is dependent on the control flow, an application ID to identify whether the data packet transmitted from the source node is an authorized data packet, and a destination IP address, and/or service ports. Additionally, the data flow table 317 may include identification information of the tunnel through which the data flow will be used. Also, the data flow table 317 may include a header (or header information) to determine whether a data packet is valid. In addition, the data flow table 317 may further include whether a data flow header, which is authentication information, is inserted into the data packet, a header insertion method, whether authentication of the data flow is required, authentication status, and/or authentication expiration time. Additionally, the data flow table 317 may include source node information (e.g., source IP) of the destination node, service port information, and receivable application information.

FIG. 4 illustrates a functional block diagram of a node (e.g., the source node 201 and the destination node 204 of FIG. 2) according to various embodiments.

Referring to FIG. 4, a node may include the processor 410, a memory 420, and the communication circuit 430. According to an embodiment, the node may further include a display 440 to interface with the user.

The processor 410 may control the overall operation of the node. In various embodiments, the processor 410 may include one processor core (single core) or may include a plurality of processor cores. For example, the processor 410 may include a multi-core such as a dual-core, a quad-core, a hexa-core, or the like. According to embodiments, the processor 410 may further include a cache memory located internally or externally. According to embodiments, the processor 410 may be configured with one or more processors. For example, the processor 410 may include at least one of an application processor, a communication processor, or a graphical processing unit (GPU).

All or a portion of processor 410 may be electrically or operatively coupled with or connected to other components (e.g., the memory 420, the communication circuit 430, or the display 440) within the node. The processor 410 may receive commands from other components of the node, may interpret the received commands, and may perform calculations or process data according to the interpreted commands. The processor 410 may interpret and process messages, data, instructions, or signals received from the memory 420, the communication circuit 430, or the display 440. The processor 410 may generate new messages, new data, new instructions, or new signals based on received messages, data, instructions, or signals. The processor 410 may provide processed or generated messages, data, instructions, or signals to the memory 420, the communication circuit 430, or the display 440.

The processor 410 may process data or signals generated or generated by a program. For example, the processor 410 may request instructions, data, or signals from the memory 420 to execute or control a program. The processor 410 may record (or store) or update instructions, data, or signals to the memory 420 in order to execute or control a program.

The memory 420 may store instructions for controlling nodes, control instruction codes, control data, or user data. For example, the memory 420 may include at least one of an application program, an operating system (OS), middleware, or a device driver.

The memory 420 may include one or more of a volatile memory or a non-volatile memory. The volatile memory may include a dynamic random access memory (DRAM), a static RAM (SRAM), a synchronous DRAM (SDRAM), a phase-change RAM (PRAM), a magnetic RAM (MRAM), a resistive RAM (RRAM), a ferroelectric RAM (FeRAM), and the like. The non-volatile memory may include a read only memory (ROM), a programmable ROM (PROM), an electrically programmable ROM (EPROM), an electrically erasable programmable ROM (EEPROM), a flash memory, and the like.

The memory 420 may further include non-volatile media such as a hard disk drive (HDD), a solid state disk (SSD), an embedded multi media card (eMMC), and universal flash storage (UFS).

According to an embodiment, the memory 420 may store some of the information included in the memory (e.g., the memory 330 in FIG. 3) of the controller. For example, the memory 420 may store the tunnel table 316 and the data flow table 317 described in FIG. 3.

The communication circuit 430 may support establishment of a wired or wireless communication connection between a node and an external electronic device (e.g., the controller 202 or gateway 203 of FIG. 2) and performing communication through the established connection. According to an embodiment, the communication circuit 430 may include a wireless communication circuit (e.g., a cellular communication circuit, a short-range wireless communication circuit, or a global navigation satellite system (GNSS) communication circuit) or a wired communication circuit (e.g., a local area network (LAN)) communication circuit, or power line communication circuit), and may communicate with external electronic devices using the corresponding communication circuit, through a short-range communication network such as Bluetooth, WiFi direct, or IrDA (infrared data association) or a long-distance communication such as a cellular network, the Internet, or a computer network. The various types of communication circuits 430 described above may be implemented as one chip or may be implemented as separate chips.

The display 440 may output content, data, or signals. In various embodiments, the display 440 may display image data processed by the processor 410. According to embodiments, the display 440 may be configured with an integrated touch screen by being combined with a plurality of touch sensors (not illustrated) capable of receiving touch input, and the like. When the display 440 is configured with the touch screen, the plurality of touch sensors may be placed above the display 440 or below the display 440.

Meanwhile, a server (e.g., the controller) according to an embodiment may include the processor 410, the memory 420, and the communication circuit 430. The processor 410, the memory 420, and the communication circuit 430 included in the server may be actually the same as the processor 410, the memory 420, and the communication circuit 430 described above.

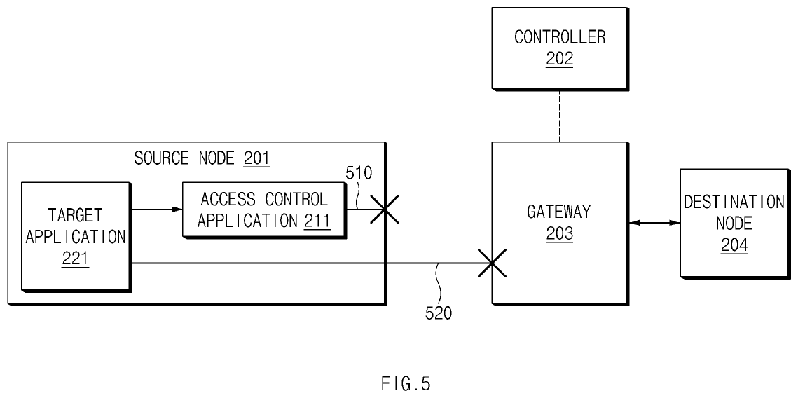

FIG. 5 illustrates an operation of controlling reception of a data packet according to various embodiments.

Referring to FIG. 5, the access control application 211 may detect an access request to the destination network including the destination node 204 of the target application 221, and may determine whether the source node 201 or the target application 221 is connected to the controller 202. When the source node 201 or the target application 221 is not connected to the controller 202, the access control application 211 may block reception of data packets from the kernel including the operating system or the network driver (operation 510). Additionally, when a data packet is received or transmitted, the access control application 211 may inspect the data packet and may ensure the safety of the received or and transmitted data packet. Through the access control application 211, the source node 201 may block access of malicious applications in advance at the application layer of the OSI layer.

According to another embodiment, when the access control application 211 is not installed on the source node 201 or a malicious application bypasses the control of the access control application 211, unauthorized data packets are transmitted from the source node 201. In this case, since the gateway 203 located at the border of the network blocks data packets received through an unauthorized tunnel (operation 520), the data packets transmitted from the source node 201 may not reach the destination node 204. In other words, the source node 201 may be isolated from the destination node 204.

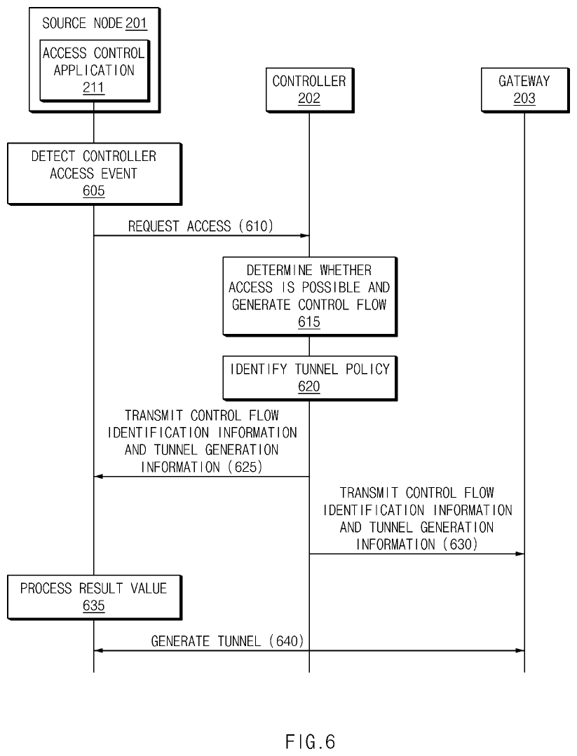

FIG. 6 illustrates a signal flow diagram for a controller access according to various embodiments.

Since the source node 201 needs to be authorized by the controller 202 to access or receive the network, the access control application 211 of the source node 201 may attempt to access the controller of the source node 201 by requesting the controller 202 to generate a control flow.

Referring to FIG. 6, in operation 605, the source node 201 may detect a controller access event. For example, the access control application 211 is installed and executed within the source node 201, and the source node 201 may detect that access to the controller 202 is requested through the access control application 211. For example, when the access control application 211 is executed, the source node 201 may receive a user input inputting the IP or domain of the controller 202, a user ID, and/or a password. For another example, when user authentication of the source node 201 is not yet completed, the source node 201 may receive a button for a controller access by an unauthorized user (i.e., a guest).

In operation 610, the source node 201 may request the controller 202 the controller access. The source node 201 may request the controller access through the access control application 211. According to an embodiment, the access control application 211 may transmit identification information (e.g., a terminal ID, an IP address, and a MAC address) of the source node 201, identification information of type, location, environment, and network to which the source node 201 belongs and/or identification information of the access control application 211 to the controller 202.

In operation 615, the controller 202 may determine whether the source node 201 is accessible in response to the received request. According to an embodiment, the controller 202 may determine whether the source node 201 is accessible based on a database included in the memory (e.g., the memory 330 in FIG. 3). For example, the controller 202 may determine whether the source node 201 is accessible based on whether information received from the access control application 211 is included in the access policy database, and whether the identification information of the source node 201 and/or the network to which the source node 201 belongs is included in the blacklist database. When the source node 201 is accessible, the controller 202 may generate a control flow between the source node 201 and the controller 202. In this case, the controller 202 may generate the control flow identification information in the form of random numbers and may store the identification information of the source node 201 and/or the network to which the source node 201 belongs in the control flow table. Information (e.g., the control flow identification information and/or the control flow information) stored in the control flow table may be used for user authentication of the source node 201, information update of the source node 201, policy verification for network access of the source node 201, and/or validation check.

According to an embodiment, when an access to the source node 201 is impossible or the source node 201 is included in the blacklist, the controller 202 may notify the source node 201 of the inability to access without performing the following operations.

In operation 620, the controller 202 may determine whether a tunnel to be generated by the source node 201 exists through the tunnel policy. When the tunnel generation is necessary, the controller 202 may generate tunnel generation information including TEP, TSP, tunnel type, method, tunnel identification information, and/or authentication information. The TEP may include a gateway IP and/or port information. In addition, when a tunnel generation is necessary, the controller 202 may set IP and DNS information to be assigned to the source node 201 and may update the corresponding information in a database (e.g., a tunnel table).

In operation 625, the controller 202 may transmit control flow identification information and tunnel generation information to the source node 201 in response to the controller access request. The control flow identification information may be used for user authentication after the controller access, update of the source node 201, or control flow identification when the network is accessed.

In operation 630, the controller 202 may transmit the control flow identification information and the tunnel generation information to the gateway 203. The tunnel generation information transmitted to the gateway 203 may include IP and DNS information to be assigned to the source node 201.

According to an embodiment, when a tunnel to be generated does not exist, the controller 202 may not perform operations 625 to 630, and when transmission of the control flow identification information and tunnel generation information to the gateway 203 fails, the controller 202 may notify the source node 201 of the result of inability to access.

In operation 635, the source node 201 may process a result value according to the received response. For example, the access control application 211 may store the received control flow identification information and may display a user interface screen indicating that the controller access is complete to the user. When the controller access is completed, the network access request with respect to the target network of the source node 201 may be controlled by the controller 202.

In operation 640, the source node 201 may generate a tunnel with the gateway 203 based on tunnel generation information. When the tunnel generation fails, the access control application 211 may output a message indicating the tunnel generation impossibility and the reason through the display, and may delete the related information.

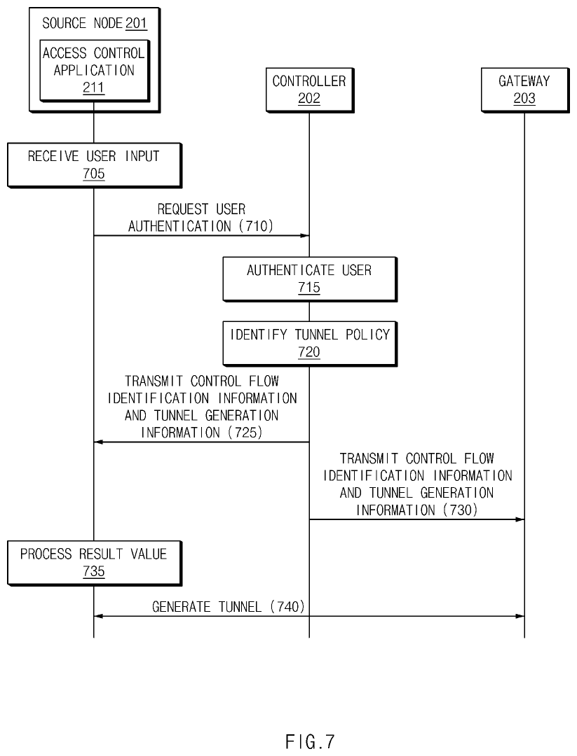

FIG. 7 illustrates a signal flow diagram for a user authentication according to various embodiments.

In order for the source node 201 to be granted detailed access rights to the destination network, the access control application 211 in source node 201 may receive authentication for the user of the source node 201 from the controller 202.

Referring to FIG. 7, in operation 705, the source node 201 may receive an input for user authentication. The input for user authentication may be, for example, a user input of entering a user ID and password. For another example, the input for user authentication may be a user input for enhanced authentication (e.g., biometric information).

In operation 710, the source node 201 may request user authentication to the controller 202. For example, the access control application 211 may transmit input information for user authentication to the controller 202. When a control flow between the source node 201 and the controller 202 is already generated, the access control application 211 may transmit input information for user authentication along with control flow identification information.

At operation 715, the controller 202 may authenticate the user based on information received from the source node 201. For example, the controller 202 may determine whether the user is accessible according to the access policy and whether the user is included in the blacklist, based on the user ID, the password, and/or enhanced authentication information included in the received information and the database (e.g., the access policy database 311 or the blacklist database 314 of FIG. 3) included in the memory of the controller 202.

When the user is authenticated, the controller 202 may add the user's identification information (e.g., user ID) to the identification information of the control flow. The added user identification information may be used to a controller access or a network access of the authenticated user.

According to an embodiment, when the user authentication is not possible or the user is included in the blacklist, the controller 202 may notify the source node 201 of the inability to access and may not perform the following operations.

When the user is authenticated, in operation 720, the controller 202 may determine whether a tunnel to be generated by the source node 201 exists through the tunnel policy. When the tunnel generation is necessary, the controller 202 may generate tunnel generation information including TEP, TSP, tunnel type, method, and/or authentication information. In addition, when tunnel generation is necessary, the controller 202 may determine whether IP and DNS information to be assigned to a user exist and, when they exit, may updates the database (e.g., a tunnel table).

In operation 725, the controller 202 may transmit control flow identification information and tunnel generation information to the source node 201 in response to the controller access request.

In operation 730, the controller 202 may transmit the control flow identification information and the tunnel generation information to the gateway 203. The tunnel generation information transmitted to the gateway 203 may include IP and DNS information to be assigned to users.

According to an embodiment, when a tunnel to be generated does not exist, the controller 202 may not perform operations 725 to 730, and when transmission of the control flow identification information and tunnel generation information to the gateway 203 fails, the controller 202 may notify the source node 201 of the result of inability to access.

In operation 735, the source node 201 may process a result value according to the received response. For example, the source node 201 may output a user interface screen indicating that user authentication is complete to the user through a display.

In operation 740, the source node 201 may generate a tunnel with the gateway 203 based on tunnel generation information. When the tunnel generation fails, the access control application 211 may output a message indicating the tunnel generation impossibility and the reason through the display, and may delete the related information.

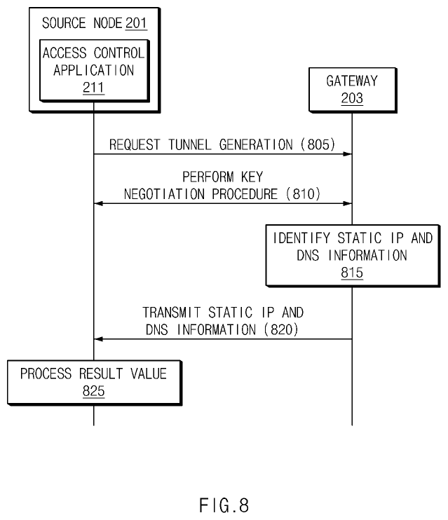

FIG. 8 illustrates a signal flow diagram for a tunnel generation according to various embodiments. Operations illustrated in FIG. 8 may be specific examples of operation 640 of FIG. 6 or operation 740 of FIG. 7.

Referring to FIG. 8, in operation 805, the source node 201 may request the gateway 203 to generate a tunnel. For example, the access control application 211 may request the gateway 203 to generate a tunnel according to the IP and port information indicated by the tunnel generation information. The access control application 211 may transmit authentication information.

In operation 810, the source node 201 and the gateway 203 may perform a key negotiation procedure based on the authentication information. When the key negotiation procedure fails, the tunnel generation request may be rejected.

In operation 815, the gateway 203 may determine whether static IP and DNS information corresponding to at least one of identification information (e.g., source node, user, or tunnel) or authentication information included in the tunnel generation request exist. The static IP may refer to a virtual IP assigned when a tunnel is generated. The DNS may be used to identify a host on the network attempting to access after the tunnel is generated. The gateway 203 may identify static IP and DNS information corresponding to identification information or authentication information based on the tunnel generation information received from the controller 203.

When the static IP and DNS information exist, in operation 820, the gateway 203 may transmit the static IP and DNS information to the source node 201.

In operation 825, the source node 201 may process a result value according to the response received from the gateway 203. For example, the access control application 211 may store the received static IP and DNS information.

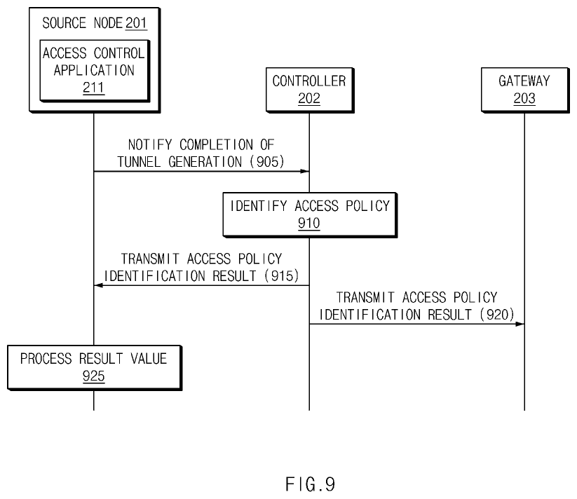

FIG. 9 illustrates a signal flow diagram for notifying completion of a tunnel generation according to various embodiments. Operations illustrated in FIG. 9 may be performed, for example, after the tunnel generation procedure of FIG. 8.

Referring to FIG. 9, in operation 905, the source node 201 may notify the controller 202 of completion of the tunnel generation. For example, the access control application 211 may transmit static IP information provided from the gateway 203 to the controller 202.

In operation 910, the controller 202 may identify the access policy. In detail, the controller 202 may determine whether the static IP information received from the source node 201 is the same as the IP information stored (or updated) in the database. Additionally, the controller 202 may determine whether the tunnel of which generation is complete satisfies the tunnel policy. When the received static IP information is the same as the IP information stored in the database, the controller 202 may generate a data flow listing the IP and port information of the target network (or the destination node) that may be transmitted with the corresponding IP.

In operations 915 to 920, the controller 201 may transmit the access policy identification result to the source node 201 and the gateway 203. For example, when the received static IP information is the same as the IP information stored in the database, the controller 202 may transmit the generated data flow to the source node 201 and the gateway 203. When the received static IP information is not the same as the IP information stored in the database, the controller 202 may request the source node 201 and the gateway 203 to remove the tunnel.

In operation 925, the source node 201 may process a result value according to information received from the controller 202. For example, the source node 201 may store the received data flow or may remove the tunnel generated with the gateway 203 according to a request from the controller 202.

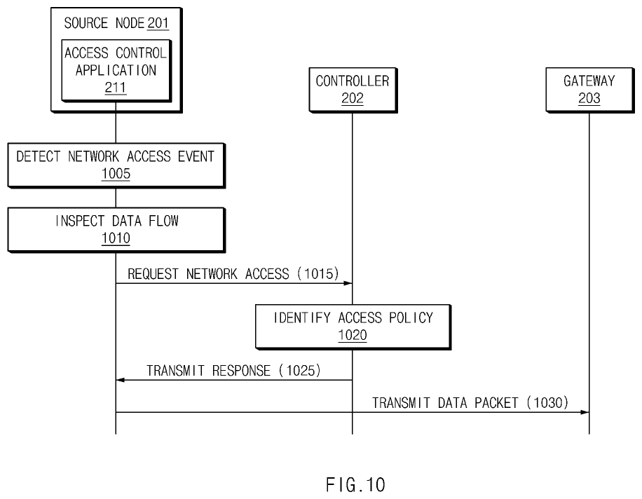

FIG. 10 illustrates a signal flow diagram for controlling a network access according to various embodiments.

After the source node 201 is authorized by the controller 202, the source node 201 may ensure trusted data transmission by controlling the network access of other applications stored in the source node 201 through the access control application 211 of the source node 201.

Referring to FIG. 10, in operation 1005, the access control application 211 may detect a network access event. For example, the access control application 211 may detect that a target application, such as a web browser, attempts to access to a target network that includes the destination node 204, such as the Internet. For example, the user may run a web browser and enter and invoke the web address to be accessed.

In operation 1010, the access control application 211 may inspect the data flow. In an embodiment, the access control application 211 may identify the target application requesting an access and the destination IP and port information, and determine whether a data flow corresponding to the identified information and an authorized tunnel for the data flow exist. there is. If a data flow and an authorized tunnel exist, the access control application 211 may skip operations 1015 to 1025 and transmit the data packet of the target application to the gateway 203 in operation 1030. When the authorized tunnel does not exist, the access control application 211 may drop the data packet.

Additionally, the access control application 211 may determine whether the data flow is valid even if the data flow exists. For example, the access control application 211 may determine that the data flow is invalid when data packets may not be transmitted or when data packet transmission is rejected by the controller 202. When the data flow is invalid, the access control application 211 may drop the data packet.

Additionally, the access control application 211 may perform a validation inspection even if the data flow does not exist. For example, the access control application 211 may perform an integrity and safety inspection (e.g., application forgery, tampering, code signing inspection, fingerprint inspection) of the target application according to the validation inspection policy, and may determine whether an access with respect to the destination IP and port of the target application is possible depending on the access policy received from the controller 202. When the validation inspection fails, the access control application 211 may drop the data packet and may display an inability message to access and reason on the display.

When the data flow does not exist but the validation inspection is successful, in operation 1015, the access control application 211 may request the controller 202 to access the network of the target application. In this case, the access control application 211 may transmit identification information of the target application and identification information (e.g., IP of the destination node and service port information) of the destination node 204 together with identification information of the control flow generated between the source node 201 and the controller 202 to the controller 202.

In operation 1020, the controller 202 may identify an access policy based on the request received from the access control application 211 and the database of the controller 202. For example, the controller 202 may determine whether the target application is accessible based on whether information received from the access control application 211 satisfies the access policy included in the database of the controller 202. When an access to the target application is not possible, in operation 1025, the controller 202 may transmit information indicating that the access is not possible to the source node 201. In this case, the access control application 211 may drop the data packet of the target application and may output a user interface screen indicating that access to the network is impossible through the display.

When the target application is accessible, in operation 1025, the controller 202 may transmit a response with respect to the network access request of the access control application 211. For example, the controller 202 may generate or update a data flow corresponding to information received from the access control application 211 and may transmit the data flow to the access control application 211. Additionally, the controller 202 may transmit the data flow to the gateway 203. In this case, when data flow transmission to the gateway 203 fails, the controller 202 may notify the access control application 211 of the inability to access.

When information indicating that the target application is accessible or a valid data flow is received, in operation 1030, the access control application 211 may transmit a data packet to the gateway 203.

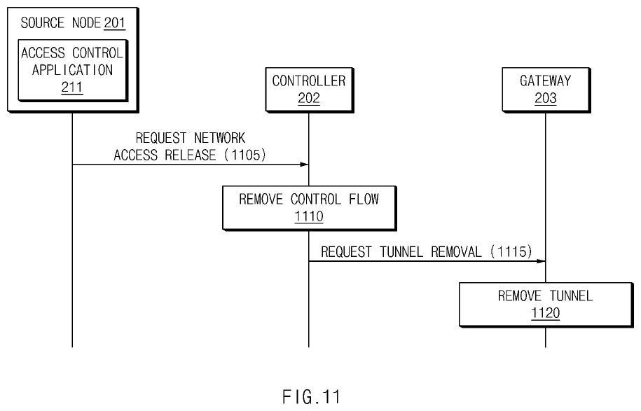

FIG. 11 illustrates a signal flow diagram for releasing a network access according to various embodiments.

Referring to FIG. 11, in operation 1105, the source node 201 may request the controller 202 to release a network access. For example, the source node 201 may transmit identification information of the control flow between the source node 201 and the controller 202 to the controller 202 along with information requesting a network access release.

According to an embodiment, the source node 201 may attempt to release the network access in response to the network access release event, such as a user request, a restart of the source node 201, or a request from the access control application 211. For example, the source node 201 may receive a user input selecting an access termination button.

In operation 1110, the controller 202 may remove (or release) the control flow corresponding to the received identification information in response to a request from the source node 201.

In operation 1115, the controller 202 may request the gateway 203 to remove the tunnel dependent on the removed control flow. In this case, the gateway 203 may remove the tunnel in response to the request from the controller 202.

Through the above-described operations, a system including the destination node 204 may provide complete blocking and isolation in which data packets transmitted from the node 201 may no longer be received.

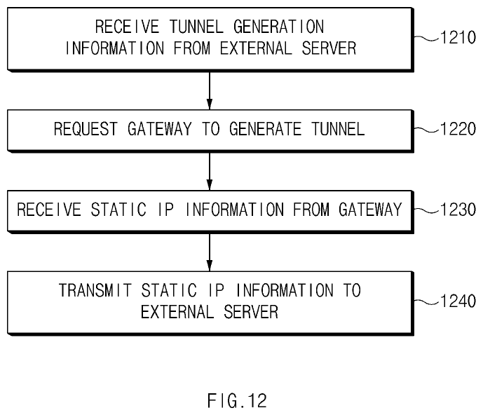

FIG. 12 illustrates a flowchart of an operation of a node for a tunnel generation according to various embodiments. Operations illustrated in FIG. 12 may be implemented by the source node 201 or a component (e.g., a processor or the access control application) included in the source node 201.

Referring to FIG. 12, in operation 1210, the node may receive tunnel generation information from an external server (e.g., the controller 202). For example, the node may receive tunnel generation information from an external server through a controller access procedure or a user authentication procedure. The tunnel generation information may include, for example, at least one of TEP, TSP, tunnel type, method, tunnel identification information, and/or authentication information.

In operation 1220, the node may request the gateway (e.g., the gateway 203) to generate the tunnel based on the tunnel generation information. For example, the node may transmit some of the tunnel generation information to the gateway.

In operation 1230, the node may receive static IP information from the gateway. Additionally, the node may receive DNS information from the gateway along with IP information. The static IP information and DNS information may be assigned by the gateway to each node or user of the node.

In operation 1240, the node may transmit the static IP information to an external server.

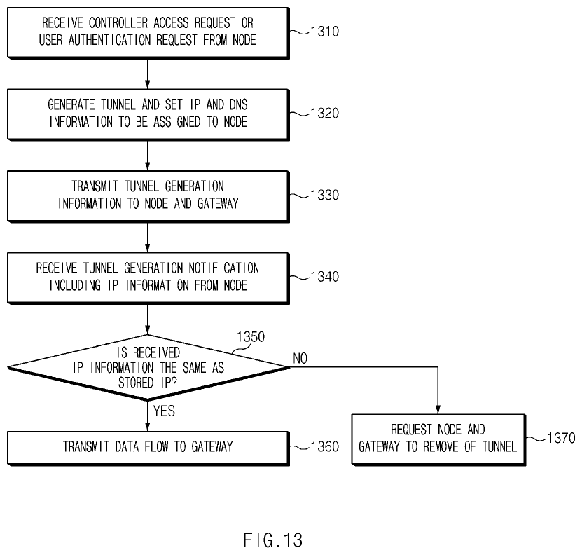

FIG. 13 illustrates a flowchart of an operation of a server for a tunnel generation according to various embodiments.

Referring to FIG. 13, in operation 1310, the server may receive a controller access request or user authentication request from the node.

When it is identified that the generation of a tunnel between the node and the gateway is necessary while performing controller access or user authentication, in operation 1320, the server may generate the tunnel generation information necessary for generation of the tunnel and may set IP and DNS information to be assigned to the node. The server may update IP and DNS information in the database.

In operation 1330, the server may transmit tunnel generation information to the node and the gateway. The tunnel generation information transmitted to the gateway may include IP and DNS information to be assigned to the node.

In operation 1340, the server may receive a tunnel generation notification including IP information from the node. The IP information received from the node may be assigned by the gateway in the tunnel generation procedure between the node and the gateway.

In operation 1350, the server may determine whether the received IP information is the same as the IP stored in the database. When the received IP information is the same as the stored IP, in operation 1360, the server may transmit the data flow to the gateway. When the received IP information is not the same as the stored IP, in operation 1370, the server may request the node and gateway to remove of the tunnel.

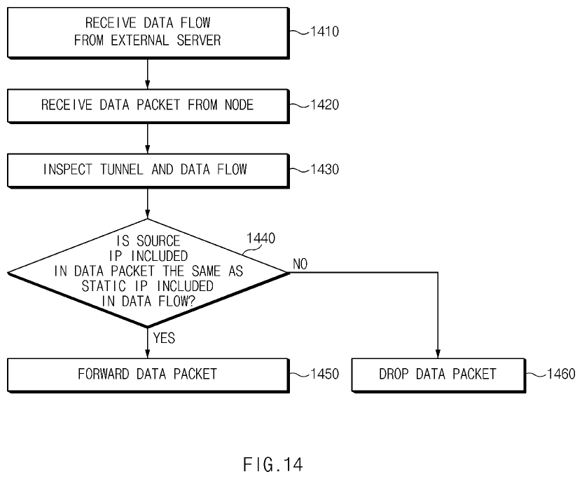

FIG. 14 illustrates a flowchart of an operation of a gateway for forwarding a data packet according to various embodiments.

Referring to FIG. 14, in operation 1410, the gateway may receive the data flow from an external server. The received data flow may indicate destination IP and port information that may be transmitted to a static IP. The static IP may be an IP assigned to a node or a user of the node when the gateway generates a tunnel with the node.

In operation 1420, the gateway may receive a data packet from the node.

In operation 1430, the gateway may determine whether the data packet is received through an authorized tunnel between the gateway and the node and whether a data flow corresponding to the source IP, destination IP, and port information included in the data packet exists. When a data packet is not received through an authorized tunnel or a data flow does not exist, the gateway may drop the data packet.

When the data packet is received through an authorized tunnel and a data flow exists, in operation 1440, the gateway may determine whether the source IP included in the data packet is the same as the static IP included in the data flow. When they are the same, in operation 1450, the gateway may forward the data packet. When they are not the same, in operation 1460 the gateway may drop the data packet.

The above description is merely illustrative of the technical idea of the present disclosure, and those of ordinary skill in the art to which the present disclosure pertains will be able to make various modifications and variations without departing from the essential characteristics of the present disclosure.

Therefore, embodiments of the present disclosure are not intended to limit the technical spirit of the present disclosure, but provided only for the illustrative purpose. The scope of protection of the present disclosure should be construed by the attached claims, and all equivalents thereof should be construed as being included within the scope of the present disclosure.

What is claimed is:

1. A node comprising:
a communication circuit;
a processor operatively connected to the communication circuit; and
a memory operatively connected to the processor and configured to store a target application and an access control application, and wherein the memory stores instructions that, when executed by the processor, cause the node to:
receive tunnel generation information necessary to generate a gateway and a tunnel from an external server, through the access control application;
request the gateway to generate the tunnel based on the tunnel generation information, through the access control application;
receive static IP information assigned to the node or each user of the node from the gateway, through the access control application; and
transmit the static IP information to the external server, through the access control application.

2. The node of claim 1, wherein the instructions cause the node to receive DNS (domain name system) information together with the static IP information from the gateway through the access control application.

3. The node of claim 1, wherein the instructions cause the node to receive a data flow indicating a destination IP and port information transmittable with the static IP from the external server through the access control application.

4. The node of claim 3, wherein the instructions cause the node to:
detect a network access event of the target application through the access control application;
determine whether the data flow exists and is valid based on identification information of the target application, a destination IP, and port information in response to the detected network access event, through the access control application;
request the external server the data flow when the data flow does not exist;
transmit a data packet of the target application when the data flow exists; and
drop the data packet of the target application when the data flow exists but is not valid.

5. The node of claim 1, wherein the instructions cause the node to:
detect an event of a controller access with respect to the external server through the access control application;
request the external server the controller access in response to the detected controller access event through the access control application;
receive a first response with respect to the controller access request from the external server through the access control application, and
wherein the first response includes identification information of a control flow generated between the access control application and the external server and the tunnel generation information.

6. The node of claim 5, wherein the instructions cause the node to:
receive a first user input requesting a user authentication;
request the external server the user authentication with respect to a user of the node through the access control application and the request of the user authentication being including information corresponding to the first user input; and
receive a second response with respect to the user authentication request from the external server through the access control application, and the second response being including a result of the user authentication request, identification information of the control flow, and the tunnel generation information.

7. The node of claim 6, wherein the instructions cause the node to:
receive a second user input requesting a release of the network access; and
request the external server to release the network access in response to the second user input.

8. A server comprising:
a communication circuit;
a memory storing a database; and
a processor operatively connected to the communication circuitry and the memory, and wherein the processor is configured to:
receive a controller access request or a user authentication request from a node, and the received request being including identification information of a control flow generated between the server and the node;
generate tunnel generation information necessary to generate a tunnel when it is necessary to generate the tunnel between the node and a gateway, and set IP and DNS information to assign to the node or a user of the node;
transmit the tunnel generation information to the node and the gateway;
receive a tunnel generation notification from the node indicating that the tunnel between the node and the gateway is generated, and the tunnel generation notification being including IP information;
determine whether the IP information included in the tunnel generation notification is the same as the set IP:
transmit a data flow including a destination IP and port information transmittable with the IP to the gateway when the IP information is the same as the IP; and
request the node and the gateway a removal of the tunnel when the IP information is not the same as the IP.

9. The sever of claim 8, wherein the processor is configured to:
receive a network access release request from the node, and the network access release request being including the identification information of the control flow;
remove the control flow corresponding to the identification information in response to the network access release request; and
remove a tunnel dependent on the removed control flow and transfer information about the removed tunnel to the gateway.

10. A gateway configured to:
from an external server, receive a data flow indicating a destination IP and port information transmittable with a static IP assigned to a node;
receive a data packet from an access control application of the node;
inspect a tunnel and data flow through which the data packet is received;
determine whether a source IP included in the data packet is the same as the static IP included in the data flow when the inspection is successful; and
drop or forward the data packet based on the determination result.

11. The gateway of claim 10, further comprising:
receiving tunnel generation information necessary for tunnel generation and IP and DNS information to be assigned to the node from the external server;
receiving a tunnel generation request from the node;
determining whether static IP and DNS information to be assigned to the node exist based on information received from the external server; and
transmitting the static IP and DNS information to the node when the static IP and DNS information exist.

12. An operating method of a node, the method comprising:
receiving tunnel generation information necessary to generate a gateway and a tunnel from an external server;
requesting the gateway to generate the tunnel based on the tunnel generation information;
receiving static IP information assigned to the node or each user of the node from the gateway; and
transmitting the static IP information to the external server.

13. An operating method of a server, the method comprising:
receiving a controller access request or a user authentication request from a node, and the received request being including identification information of a control flow generated between the server and the node;
generating tunnel generation information necessary for a tunnel generation and setting IP and DNS information to be assigned to the node or a user of the node when it is necessary to generate a tunnel between the node and a gateway;
transmitting the tunnel generation information to the node and the gateway;
receiving a tunnel generation notification from the node indicating that the tunnel between the node and the gateway is generated, and the tunnel generation notification being including IP information;
determining whether IP information included in the tunnel generation notification is the same as the set IP; and
transmitting a data flow including a destination IP and port information transmittable with the IP to the gateway when the IP information is the same as the IP, and requesting the node and the gateway to remove the tunnel when the IP information is not the same as the IP.

14. An operating method of a gateway, the method comprising:
receiving, from an external server, a data flow indicating a destination IP and port information transmittable with a static IP assigned to a node;
receiving a data packet from an access control application of the node;
inspecting a tunnel and data flow through which the data packet is received;
determining whether a source IP included in the data packet is the same as the static IP included in the data flow when the inspection is successful; and
dropping or forwarding the data packet based on the determination result.
